(19) United States
(12) Patent Application Publication
(10) Pub. No.: US 2020/0255624 A1
(43) Pub. Date: Aug. 13, 2020

(54) LATEX STABILIZER FOR SYNTHETIC LATEX AND METHODS OF USE

(71) Applicant: Halliburton Energy Services, Inc., Houston, TX (US)

(72) Inventors: Jeffrey J. MILLER, Spring, TX (US); Srinivasan SRIKANTH, Sugar Land, TX (US); Shubhajit GHOSH, Houston, TX (US)

(21) Appl. No.: 16/336,835

(22) PCT Filed: Dec. 16, 2016
(86) PCT No.: PCT/US16/67094

§ 371 Date: Mar. 26, 2019

(51) Int. Cl. C08K 5/053; C09K 8/035; C09K 8/467; C09K 8/588

(52) U.S. Cl. CPC C08K 5/053; C09K 8/588; C09K 8/467; C09K 8/035

(57) ABSTRACT

Provided are compositions, systems, and methods of using a synthetic latex composition for treating a subterranean formation. An example method comprises providing a synthetic latex composition comprising: a synthetic latex and a latex stabilizer; and exposing the synthetic latex composition to air for an exposure period of at least one day; wherein the synthetic latex composition loses less than 5% of its initial water concentration at the end of a one-day exposure period. The synthetic latex composition may be further included in a treatment fluid. The treatment fluid may be introduced into a wellbore penetrating a subterranean formation.

### TECHNICAL FIELD

The present disclosure relates to the use and production of a synthetic latex composition comprising a latex stabilizer, and more particularly to stabilizing a synthetic latex composition with a latex stabilizer, exposing said stabilized synthetic latex composition to air, and then introducing the stabilized synthetic latex composition to a treatment fluid after it has been exposed.

### BACKGROUND

Latex is the stable dispersion of rubber microparticles in an aqueous medium and may be natural or synthetic. Latex is used in the oilfield industry as an additive for treatment fluids such as drilling fluids and cements. Generally, latex may be used to provide gas-migration control, fluid-loss control, and improved durability to the treatment fluid.

Synthetic latices may be produced by polymerizing and emulsifying a monomer such as styrene, butadiene, etc. Synthetic latices may be used in many oilfield applications because of their preferred composition and their reduced cost compared to natural latices. Synthetic latices may form films through coalescence if the water in the emulsion evaporates. Typically, such evaporation may occur if the latex storage container is not sealed and the latex is exposed to an open-air environment for too long. If enough water evaporates, the latex hardens into a mass that may not be suitable for use. The hardened mass may be difficult to mix into the treatment fluid. Further, the hardened mass may damage and/or clog equipment. In such instances the hardened mass is typically disposed of. Moreover, synthetic latices are typically not freeze-stable, and storage or use of the latex in freezing environments may destabilize the emulsion and result in a latex that cannot be used when thawed.

In order to resolve the aforementioned issues various engineering controls have been deployed to deal with latex that has hardened. For example, the latex may be recirculated in an attempt to break up a mass and emulsify the latex again. This method is not always successful and may require surfactants and additional water to be added to the latex to achieve emulsification. Alternatively, the latex may be heated to break up the mass. This approach may also require additional water and surfactants. In both instances the latex may not mix well, may have its composition undesirably altered, and/or may be unusable even after application of these corrective measures. Further, if the latex forms a hardened mass, it may need to be filtered before or during use so that it does not clog any fluid conduits. The filtered mass may then be disposed of, generating waste and requiring additional latex to be added to substitute for the destroyed amount. This waste increases operational costs and requires additional oversight and time to remove and correct.

### BRIEF DESCRIPTION OF THE DRAWINGS

Illustrative examples of the present disclosure are described in detail below with reference to the attached drawing figures, which are incorporated by reference herein, and wherein:

FIG. 1 illustrates a schematic of a system for the preparation and delivery of a treatment fluid to a wellbore in accordance with the disclosed examples;

FIG. 2A illustrates a schematic of a system of surface equipment that may be used in the placement of a treatment fluid in a wellbore in accordance with the disclosed examples;

FIG. 2B illustrates a schematic of a system used for the placement of a cement composition comprising the synthetic latex composition into a wellbore annulus in accordance with the disclosed examples;

FIG. 3 illustrates a schematic of a system used for the drilling of a wellbore with a drilling fluid comprising the synthetic latex composition in accordance with the disclosed examples;

FIG. 4 is a photograph illustrating a comparative example of a synthetic latex composition and stabilized latex blend after 24 hours of exposure to an open-air environment;

FIG. 5 is a graph of percent water loss over time for a comparative example; and

FIG. 6 is a graph illustrating a comparison of the HTHP filtrate for synthetic-based fluid samples treated with the synthetic latex composition.

The illustrated figures are only exemplary and are not intended to assert or imply any limitation with regard to the environment, architecture, design, or process in which different examples may be implemented.

### DETAILED DESCRIPTION

The present disclosure relates to the use and production of a synthetic latex composition comprising a latex stabilizer, and more particularly to stabilizing a synthetic latex composition with a latex stabilizer, exposing said stabilized synthetic latex composition to air, and then introducing the stabilized synthetic latex composition to a treatment fluid after it has been exposed.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the examples of the present invention. At the very least, and not as an attempt to limit the application of the doctrine of equivalents to the scope of the claim, each numerical parameter should at least be construed in light of the number of reported significant digits and by applying ordinary rounding techniques. It should be noted that when “about” is at the beginning of a numerical list, “about” modifies each number of the numerical list. Further, in some numerical listings of ranges some lower limits listed may be greater than some upper limits listed. One skilled in the art will recognize that the selected subset will require the selection of an upper limit in excess of the selected lower limit.

Examples of the compositions and methods described herein comprise the production and use of a synthetic latex composition comprising a latex stabilizer. The synthetic latex composition is storable in open-air environments and may be exposed to air. As used herein, “storable” and all variations thereof refers to the storage of the synthetic latex composition in a homogenous state. As used herein, “homogenous” refers to an emulsion having a range of density from the top of the container to the bottom of the container of less than 0.3 pounds per gallon (hereafter “ppg”). The synthetic latex composition may be free of solids of a size sufficient to be retained on a 80-mesh sieve of the U. S. Sieve Series after exposure to air. In a preferred composition, the synthetic latex may also be free of solids of a size sufficient to be retained on a 200-mesh sieve of the U. S. Sieve Series after exposure to air. The synthetic latex composition may also comprise a viscosity that does not vary more than 20% from the top of the container to the bottom after exposure to air. As used herein, “open-air environment” and all variations thereof refers to the exposure of the synthetic latex composition to an environment in which a volume of air is unrestricted in its contact of the fluid/air interface between the synthetic latex composition and the volume of air. A non-limiting example of exposure to an open-air environment is the storage of the synthetic latex composition in a container that is at least partially unsealed. As used herein, “air” and all variations thereof refers to any or all of the atmospheric gases. The synthetic latex composition may be freeze-stable. As used herein, “freeze-stable” refers to a synthetic latex composition that remains homogenous and emulsified in an environment in which the temperature of the synthetic latex composition is below 32° F.

Examples of the synthetic latex compositions comprise a synthetic latex. The synthetic latex is the stable dispersion of rubber microparticles in an aqueous medium. As will be understood by those of ordinary skill in the art, the latex may comprise any of a variety of rubber materials available in latex form. The synthetic latex may comprise synthetic polymers of various types including, but not limited to, styrene-butadiene rubber, cis-1,4-polybutadiene rubber, high styrene resin, butyl rubber, ethylene-propylene rubbers, neoprene rubber, nitrile rubber, cis-/trans-1,4-polyisoprene rubber, silicone rubber, chlorosulfonated polyethylene rubber, crosslinked polyethylene rubber, epichlorohydrin rubber, fluorocarbon rubber, fluorosilicone rubber, polyurethane rubber, polyacrylic rubber, polysulfide rubber, blends thereof, derivatives thereof, or combinations thereof. The rubber materials may be commercially available in latex form, i.e., aqueous dispersions or emulsions which are utilized directly. With the benefit of this disclosure, one of ordinary skill in the art will be able to select a species of synthetic latex for a given application.

The synthetic latex composition comprises a latex stabilizer. Generally, the latex stabilizer is a polyol. Various classes of polyols may be used, including monomeric polyols, polymeric polyols, cyclic polyols, sugar alcohols, etc. Some examples of polyols include, but are not limited to, glycerin, pentaerythritol, ethylene glycol, propylene glycol, ethylene glycol, diethylene glycol, 1,4-butanediol, polyethylene glycol, polypropylene glycol, poly(tetramethylene ether), bornesitol, inositol, maltitol, sorbitol, xylitol, the like, derivatives thereof, or mixtures thereof. Without limitation by theory, the latex stabilizer may reduce the rate of water loss of the synthetic latex composition when the synthetic latex composition is stored in and/or exposed to air. Additionally, the latex stabilizer may impart freeze-stability to the synthetic latex composition such that the synthetic latex composition may comprise a temperature of 32° F. and may remain homogenous and emulsified. Lower molecular weight polyols (e.g., molecular weights less than 200) may be preferred in some examples to maintain a lower viscosity latex. For example, oligomeric polyols of low molecular weight may be easier to mix and use compared to polymeric polyols with high numbers of monomer units and high molecular weights. With the benefit of this disclosure, one of ordinary skill in the art will be able to select a species of latex stabilizer for a given application.

In some examples, the concentration of the latex stabilizer in the synthetic latex composition may be in the range of about 0.5% to about 40% w/w. The concentration of the latex stabilizer may range from any lower limit to any upper limit and encompass any subset between the upper and lower limits. Some of the lower limits listed may be greater than some of the listed upper limits. One skilled in the art will recognize that the selected subset may require the selection of an upper limit in excess of the selected lower limit. Therefore, it is to be understood that every range of values is encompassed within the broader range of values. For example, the concentration of the latex stabilizer in the synthetic latex composition may be about 0.5%, about 1%, about 2%, about 5%, about 10%, about 15%, about 20%, about 25%, about 30%, about 35%, or about 40% w/w. However, concentrations outside these defined ranges also may be suitable for particular applications. In a preferred example, the concentration of the latex stabilizer in the synthetic latex composition may be about 20% w/w. With the benefit of this disclosure, one of ordinary skill in the art will be able to select a concentration of latex stabilizer for a given application.

As previously mentioned, the synthetic latex composition may be exposed to air and/or stored in an open-air environment. The synthetic latex composition may remain homogenous while exposed to air. The synthetic latex composition may also be free of solids of a size sufficient to be retained on a 80-mesh sieve of the U. S. Sieve Series after exposure to air. The synthetic latex composition may also comprise a viscosity that does not vary more than 20% from the top of the container to the bottom after exposure to air. The synthetic latex composition is further characterized in that the degree of water loss from exposure to air is reduced relative to the same synthetic latex without a latex stabilizer when exposed to air. For example, the synthetic latex composition may maintain 80% or more of its initial water volume after 1 day, 2 days, 3 days, 4 days, 5 days, 6 days, 7 days, or longer while exposed to air. As a further example, the synthetic latex composition may maintain about 80%, about 85%, about 90%, about 95% or more of its initial water volume after exposure to air. An example method of using the synthetic latex composition comprises storing the synthetic latex composition in an open-air environment for 7 days; wherein the synthetic latex composition maintains 80% or more of its initial water volume after 7 days and then using the synthetic latex composition in a treatment fluid. For example, containers of the synthetic latex composition may be exposed to air as the synthetic latex composition is partially used over several hours or multiple days as needed until the entire volume has been placed in the treatment fluid, increasing the contact with air as time elapses. Alternatively, the synthetic latex composition may be exposed to air after addition to the treatment fluid, for example, after preparation, the treatment fluid may be left in an unsealed container or during use the treatment fluid may contact air in the conduits used to convey the treatment fluid.

As previously mentioned, the synthetic latex composition may be freeze-stable. The synthetic latex composition may remain homogenous and emulsified in an environment in which the temperature of the synthetic latex composition is below 32° F. As such, the stable emulsion of the synthetic latex composition does not break at temperatures of about 32° F., about 31° F., about 30° F., about 29° F., about 28° F., about 27° F. about 26° F. about 25° F., about 24° F., about 23° F. about 22° F., about 21° F., about 20° F., or lower. An example method of using the synthetic latex composition comprises allowing the synthetic latex composition to have a temperature of 32° F. or lower and then using the synthetic latex composition in a treatment fluid.

When desired for use, the synthetic latex composition may be added to a treatment fluid to alter the properties of the treatment fluid as desired. The treatment fluid may be introduced into a wellbore to perform a wellbore operation. The synthetic latex composition may be added to a variety of treatment fluids used in wellbore operations. Examples of treatment fluids include, but are not limited to, drilling fluids, cement slurries, completion fluids, displacement fluids, conformance fluids, and the like. The concentration of the synthetic latex composition in the treatment fluid is dependent upon the amount of synthetic latex composition required to produce a desired change in a property of the treatment fluid.

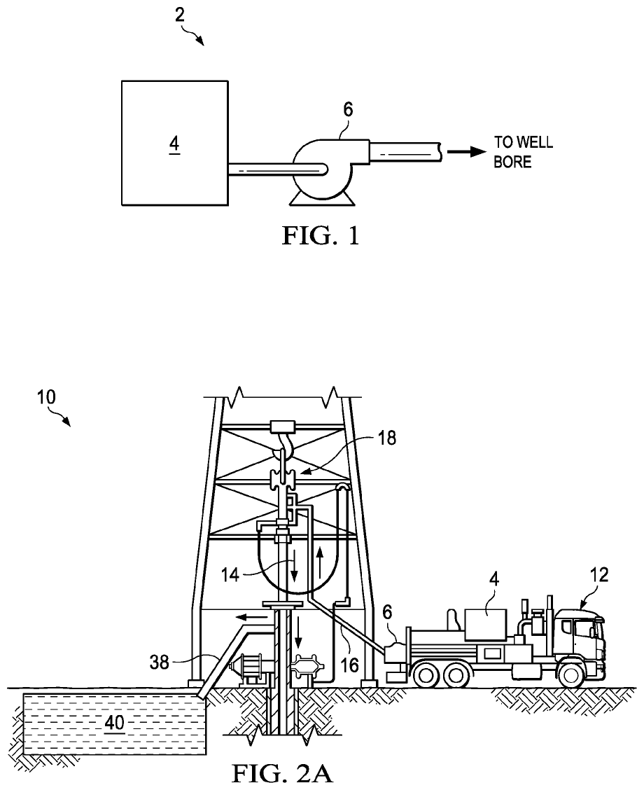

Referring now to FIG. 1, preparation of a treatment fluid comprising the synthetic latex composition will now be described in accordance with the examples disclosed herein. FIG. 1 illustrates a system 2 for preparation of a treatment fluid comprising the synthetic latex composition. The synthetic latex composition may be added to a treatment fluid and mixed in mixing equipment 4. The synthetic latex composition may be added manually, or via pumping through a diaphragm pump or the like. Mixing equipment 4 may be any mixer sufficient for mixing the synthetic latex composition with the treatment fluid or at least one of the components of the treatment fluid in order to provide a treatment fluid with the desired properties. Examples of mixing equipment 4 may include, but are not limited to, a jet mixer, re-circulating mixer, a batch mixer, and the like. In some examples, mixing equipment 4 may be a jet mixer and may continuously mix the treatment fluid as it is pumped to the wellbore. The synthetic latex composition may be added to mixing equipment 4 first or, alternatively, the treatment fluid may be added to mixing equipment 4 first. In some examples, the treatment fluid may be formulated in mixing equipment 4 such that the components of the treatment fluid, including the synthetic latex composition, may be added to the mixing equipment 4 in any order and mixed to provide the desired treatment fluid.

In some examples, the synthetic latex composition may be exposed to air (e.g., by storage in an open-air environment or exposure to air in conduits, mixing tanks, pumps, etc.) prior to addition to mixing equipment 4 and/or prior to addition to the treatment fluid. For example, the synthetic latex composition may be stored in an open-air environment for 1 day, 2 days, 3 days, 4 days, 5 days, 6 days, 7 days, or longer and then added to the mixing equipment 4 and/or the treatment fluid. In alternative examples, the synthetic latex composition may be exposed to air after addition to the treatment fluid. For example, the treatment fluid may be exposed to air (e.g., by storage in an open-air environment or exposure to air in conduits, mixing tanks, pumps, etc.) for 1 day, 2 days, 3 days, 4 days, 5 days, 6 days, 7 days, or longer before or during use. In examples, during and after exposure to air, the synthetic latex composition may remain homogenous. In examples, during and after exposure to air, the synthetic latex composition may maintain 80% or more of its initial water volume. In examples, the synthetic latex composition may also be free of solids of a size sufficient to be retained on a 200-mesh sieve of the U. S. Sieve Series after exposure to air. In examples, the synthetic latex composition may also comprise a viscosity that does not vary more than 20% from the top of the container to the bottom after exposure to air.

In some examples, the synthetic latex composition may be allowed to have a temperature of 32° F. or lower prior to addition to mixing equipment 4 and/or prior to addition to the treatment fluid. For example, the synthetic latex composition may have a temperature of about 32° F., about 31° F., about 30° F., about 29° F., about 28° F., about 27° F. about 26° about 25° F., about 24° F., about 23° F. about 22° F., about 21° F., about 20° F., or lower and then be added to the mixing equipment 4 and/or the treatment fluid. In examples, the synthetic latex composition may remain homogenous and emulsified at a temperature of 32° F. or lower.

After the synthetic latex composition has been added to the treatment fluid and mixed in mixing equipment 4 to provide a treatment fluid with a desired property and composition, the treatment fluid may be pumped to the wellbore via pumping equipment 6. In some examples, the mixing equipment 4 and the pumping equipment 6 may be disposed on one or more cement trucks as will be apparent to those of ordinary skill in the art. Examples of pumping equipment 6 include, but are not limited to, floating piston pumps, positive displacement pumps, centrifugal pumps, peristaltic pumps, and diaphragm pumps.

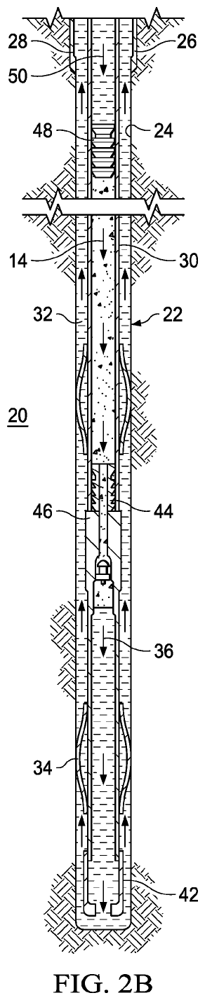

With reference to FIGS. 2A and 2B, an example technique for placing a treatment fluid comprising the synthetic latex composition is described. Specifically, the placement of a cement composition comprising the synthetic latex composition is described. The synthetic latex composition may be added to the cement composition after exposure to air and/or after having a temperature of 32° F. or lower as discussed in FIG. 1. FIG. 2A illustrates surface equipment 10 that may be used in placement of a cement composition in accordance with certain examples disclosed herein. It should be noted that while FIG. 2A generally depicts a land-based operation, those skilled in the art will readily recognize that the principles described herein are equally applicable to subsea operations that employ floating or sea-based platforms and rigs without departing from the scope of the disclosure. As illustrated by FIG. 2A, the surface equipment 10 may include a cementing unit 12, which may include one or more cement trucks. The cementing unit 12 may include mixing equipment 4 and pumping equipment 6 as will be apparent to those of ordinary skill in the art. The cementing unit 12 may pump a cement composition 14 through feed pipe 16 and to a cementing head 18, which conveys the cement composition 14 downhole into a wellbore.

Turning now to FIG. 2B, the cement composition 14 may be placed into a subterranean formation 20 in accordance with certain examples. As illustrated, a wellbore 22 may be drilled into the subterranean formation 20. While wellbore 22 is shown extending vertically into the subterranean formation 20, the principles described herein are also applicable to wellbores that extend at an angle through the subterranean formation 20, such as horizontal and slanted wellbores. As illustrated, the wellbore 22 comprises walls 24. A surface casing 26 has been inserted into the wellbore 22. The surface casing 26 may be cemented to the walls 24 of the wellbore 22 by cement sheath 28. In the illustrated embodiment, casing 30 is disposed in the wellbore 22. In some examples, one or more additional conduits (e.g., intermediate casing, production casing, liners, tubing, coiled tubing, jointed tubing, stick pipe, etc.) may also be disposed in the wellbore 22. As illustrated, there is a wellbore annulus 32 formed between the casing 30 and the walls 24 of the wellbore 22 and/or the surface casing 26. One or more centralizers 34 may be attached to the casing 30, for example, to centralize the casing 30 in the wellbore 22 prior to and during the cementing operation.

With continued reference to FIG. 2B, the cement composition 14 may be pumped down the interior of the casing 30. The cement composition 14 may be allowed to flow down the interior of the casing 30 through the casing shoe 42 at the bottom of the casing 30 and up around the casing 30 into the wellbore annulus 32. The cement composition 14 may be allowed to set in the wellbore annulus 32, for example, to form a cement sheath that supports and positions the casing 30 in the wellbore 22. While not illustrated, other techniques may also be utilized for introduction of the cement composition 14. By way of example, reverse circulation techniques may be used that include introducing the cement composition 14 into the subterranean formation 20 by way of the wellbore annulus 32 instead of through the casing 30.

As it is introduced, the cement composition 14 may displace other fluids 36, such as drilling fluids and/or spacer fluids that may be present in the interior of the casing 30 and/or the wellbore annulus 32. In some examples, these displaced other fluids 36 may also be treatment fluids comprising the disclosed synthetic latex composition. At least a portion of the displaced other fluids 36 may exit the wellbore annulus 32 via a flow line 38 and be deposited, for example, in one or more retention pits 40 (e.g., a mud pit), as shown on FIG. 2A. Referring again to FIG. 2B, a bottom plug 44 may be introduced into the wellbore 22 ahead of the cement composition 14, for example, to separate the cement composition 14 from the other fluids 36 that may be inside the casing 30 prior to cementing. After the bottom plug 44 reaches a landing collar 46, a diaphragm or other suitable device may rupture to allow the cement composition 14 through the bottom plug 44. In FIG. 2B, the bottom plug 44 is illustrated as positioned on the landing collar 46. In the illustrated example, a top plug 48 may be introduced into the wellbore 22 behind the cement composition 14. The top plug 48 may separate the cement composition 14 from a displacement fluid 50 and push the cement composition 14 through the bottom plug 44. When positioned as desired, the cement composition 14 may then be allowed to set. In some examples, the displacement fluid 50 may comprise the disclosed synthetic latex composition to provide the displacement fluid 50 with a desired property.

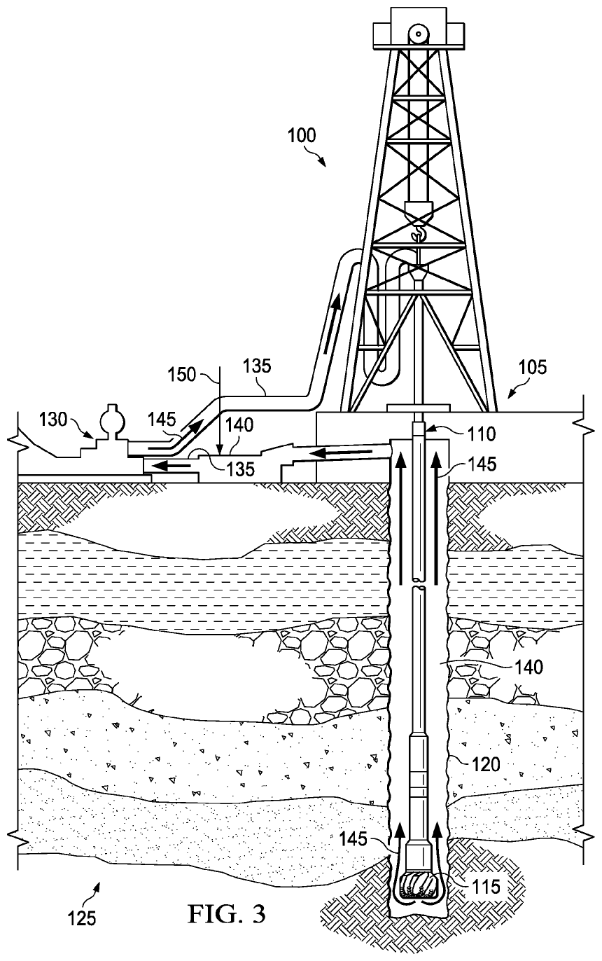

FIG. 3 is a schematic showing one example of a drilling assembly 100 suitable for drilling with a treatment fluid comprising the synthetic latex composition. Specifically, the drilling of a wellbore 120 with a drilling fluid 145 comprising the synthetic latex composition. The synthetic latex composition may be added to the drilling fluid after exposure to air and/or after having a temperature of 32° F. or lower as discussed in FIG. 1. It should be noted that while FIG. 3 generally depicts a land-based drilling assembly, those skilled in the art will readily recognize that the principles described herein are equally applicable to subsea drilling operations that employ floating or sea-based platforms and rigs, without departing from the scope of the disclosure.

The drilling assembly 100 includes a drilling platform 105 coupled to a drill string 110. The drill string 110 may include, but is not limited to, drill pipe and coiled tubing, as generally known to those skilled in the art apart from the particular teachings of this disclosure. A drill bit 115 is attached to the distal end of the drill string 110 and is driven either by a downhole motor and/or via rotation of the drill string 110 from the well surface. As the drill bit 115 rotates, it creates a wellbore 120 that penetrates the subterranean formation 125. The drilling assembly 100 also includes a pump 130 (e.g., a mud pump) that circulates a drilling fluid 145 through a feed pipe 135 to the drill string 110, down the interior of the drill string 110, through one or more orifices in the drill bit 115, and into the annular space 140 between the drill string 110 and walls of the wellbore 120.

The drilling fluid 145 is then circulated back to the surface via annulus 140. At the surface, the recirculated or spent drilling fluid 145 exits the annulus 140 and may be processed and cleaned before being passed to a retention pit 145. The cleaned drilling fluid 145 may then be reintroduced into the wellbore 120 via pump 130 if desired.

In some examples, the synthetic latex composition may be added to the drilling fluid 145 via mixing equipment 150 communicably coupled to or otherwise in fluid communication with the retention pit 140. The mixing equipment 150 may include, but is not limited to, mixers and related mixing equipment known to those skilled in the art. In other examples, however, the synthetic latex composition may be added to the drilling fluid 145 at any other location in the drilling assembly 100. In at least one example, there could be more than one retention pit 140, such as multiple retention pits 140 in series. Moreover, the retention pit 140 may be representative of one or more fluid storage facilities and/or units where the synthetic latex composition may be stored until added to the drilling fluid 145.

One skilled in the art would recognize the other equipment suitable for use in conjunction with drilling assembly 100, which may include, but is not limited to, mixers, shakers (e.g., shale shaker), centrifuges, hydrocyclones, separators (including magnetic and electrical separators), desilters, desanders, filters (e.g., diatomaceous earth filters), heat exchangers, and any fluid reclamation equipment. Further, the drilling assembly 100 may include one or more sensors, gauges, pumps, compressors, and the like.

It is also to be recognized that the disclosed treatment fluids may also directly or indirectly affect the various downhole equipment and tools that may come into contact with the treatment fluids during operation. Such equipment and tools may include, but are not limited to, wellbore casing, wellbore liner, completion string, insert strings, drill string, coiled tubing, slickline, wireline, drill pipe, drill collars, mud motors, downhole motors and/or pumps, surface-mounted motors and/or pumps, centralizers, turbolizers, scratchers, floats (e.g., shoes, collars, valves, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like. Any of these components may be included in the systems generally described above and depicted in FIGS. 1-3.

### EXAMPLES

The present disclosure can be better understood by reference to the following examples which are offered by way of illustration. The present disclosure is not limited to the examples given herein.

### Example 1

Experimental styrene-butadiene latex samples were prepared to compare the effectiveness of various latex stabilizers. For each sample, 20 grams of a latex stabilizer were added to 80 grams of the synthetic latex to provide a 20% by weight concentration.

In sample 1, glycerin was used as the latex stabilizer. This stabilizer was fully compatible with the latex, and resulted in a lower viscosity than the initial latex. The blend remained fluid and had minimal change after exposure to air and storage in an open-air laboratory environment for 5 days.

In sample 2, ethylene glycol was used as the latex stabilizer. This stabilizer was not compatible with the latex, and resulted in polymer agglomerates on initial blending. The blend remained fluid yet still had polymer agglomerates after storing in an open-air laboratory environment for 5 days. The synthetic latex composition was usable, but the blend was not preferred as it generated waste and was difficult to mix.

In sample 3, polyethylene glycol at a 200-molecular weight was used as the latex stabilizer. This stabilizer caused the latex to form a viscous paste. The blend was not usable and low molecular weight polyols are preferred.

In sample 4, isopropanol was used as the latex stabilizer. Isopropanol is not a polyol. This potential stabilizer caused an immediate precipitation of polymer from the aqueous solution. The blend was not usable.

### Example 2

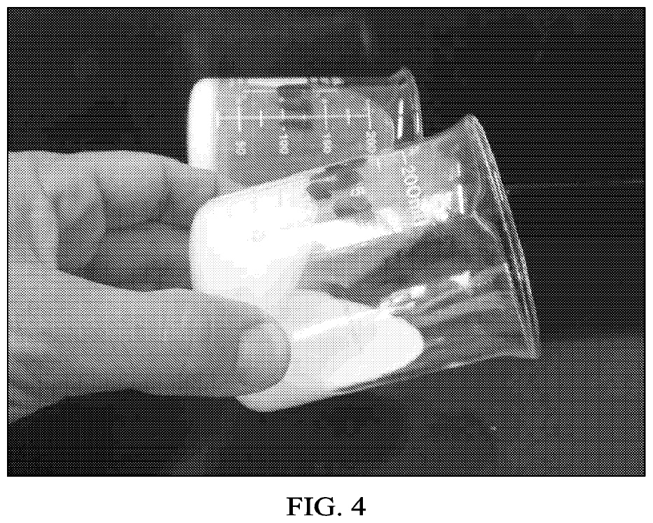

Experimental and control styrene-butadiene latex samples were prepared. For the experimental sample, 20 g of a glycerin latex stabilizer was added to 80 g of latex to provide a 20% weight concentration. The latex stabilizer was sufficiently mixed with the synthetic latex to disperse the latex stabilizer within the synthetic latex. The samples were stored in glass beakers without lids, covering, or sealing of any kind and were exposed to the surrounding open-air environment as illustrated in FIG. 4.

FIG. 4 is a photograph illustrating the control sample in the background and the experimental sample in the foreground after 24 hours of exposure to an open-air environment. As illustrated by FIG. 4, the control sample has begun to harden and does not flow, whereas the experimental sample is flowable with no polymer coagulation.

New samples of the experimental and control latex compositions were prepared and placed in sealed glass jars. These were placed in a freezer at a temperature of −8° F. for 72 hours. When the samples were removed from the freezer and evaluated, the control sample was completely solid and showed no fluidity. The latex with glycerin stabilizer remained fully fluid, and had such viscosity to allow for normal handling at this low temperature.

### Example 3

Experimental and control styrene-butadiene latex samples were prepared. For the experimental sample, 2 pounds of a glycerin latex stabilizer was added to 8 pounds of latex to provide a 20% weight concentration. The latex stabilizer was sufficiently mixed with the synthetic latex to disperse the latex stabilizer within the synthetic latex. The total mass of the latex samples were recorded, and the water fraction was calculated based on the solids content. The samples were stored in glass beakers without lids or seals of any kind and were exposed to the surrounding open-air environment for a period of 7 days. Samples were routinely mixed by hand to ensure maximum contact with the air.

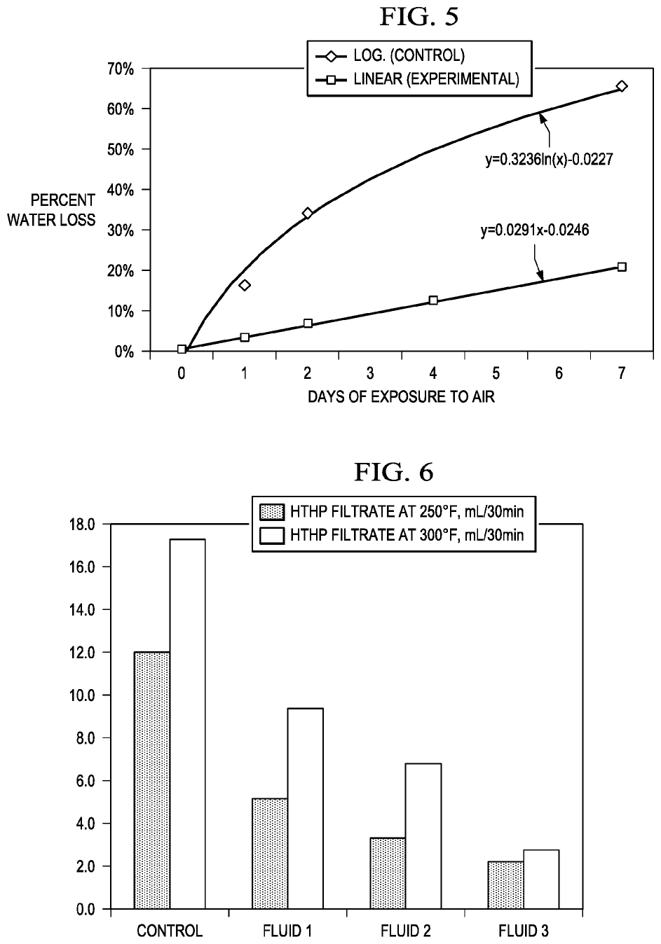

FIG. 5 is a graph of percent water loss over time for the control sample and the experimental sample. Over a 1-day period the control sample lost over 16% of its initial water and formed a dried polymer surface. For the same period the experimental sample lost only 3% of its initial water. Over a 2-day period the experimental sample had a water loss of less than 10% following a slope of about 2.9% water loss per day. For the same period the control sample had lost over 30% of its initial water, and a large portion of it had become a solidified, unusable mass that could not be remixed without difficulty. The control sample showed a logarithmic water loss over the 7-day period with a final loss of 66% of the initial water. The experimental sample had a final water loss of 20% for the same period and remained flowable, remixable, homogeneous and usable. FIG. 4 illustrates that a synthetic latex composition comprising a latex stabilizer may experience a near linear water loss if exposed to an open-air environment, whereas a synthetic latex which does not comprise a latex stabilizer may experience a logarithmic water loss if exposed to an open-air environment.

### Example 4

A sample of 20% weight glycerin-stabilized styrene-butadiene latex was prepared and tested in three synthetic-based drilling fluid samples to provide an example of polymer function after delivery into the treatment fluid. The control sample shows a suitable rheology profile after mixing and also after heat rolling for 16 hours at 275° F. Without any polymer addition, the HTHP filtrate volumes were 12.0 and 17.2 mL at test temperatures of 250° F. and 300° F., respectively. Testing was performed in accordance with ANSI/API RP 13B-2: Recommended Practice for Field Testing Oil-based Drilling Fluids. Fluids 1, 2, and 3 were treated with varying amounts of the synthetic latex composition and evaluated.

Fluid 1 showed a significant reduction in filtrate values with addition of 1.5 pounds per barrel equivalent of stabilized latex. The subsequent samples had further reductions in filtrate with higher treatment concentrations. Table 1 shows the Formulas mixed and resulting properties for these samples.

TABLE 1

| Components in order of | | | | | |
|---|---|---|---|---|---|
| addition | Control | | Fluid 1 | Fluid 2 | Fluid 3 |
| Synthetic base fluid, ppb | 148 | | 148 | 148 | 148 |
| Emulsifier, ppb | 14 | | 14 | 14 | 14 |
| Lime, ppb | 4 | | 4 | 4 | 4 |
| CaCl2, ppb | 16.3 | | 16.3 | 16.3 | 16.3 |
| Water, ppb | 46.9 | | 46.9 | 46.9 | 46.9 |
| Barite, ppb | 322 | | 322 | 322 | 322 |
| Liquid rheology modifier, ppb | 0.8 | | 0.8 | 0.8 | 0.8 |
| Simulated drill solids, ppb | 38 | | 38 | 38 | 38 |
| Stabilized latex blend, ppb | 0 | | 1.5 | 2.0 | 3.0 |
| Hot Rolled at 275° F., hours | 0 | 16 | 16 | 16 | 16 |

Fann 35 Dial Readings @ 120° F.

| | | | | | |
|---|---|---|---|---|---|
| 600 rpm | 68 | 69 | 85 | 88 | 99 |
| 300 rpm | 43 | 45 | 54 | 56 | 62 |
| 200 rpm | 33 | 35 | 44 | 45 | 50 |
| 100 rpm | 24 | 25 | 31 | 32 | 35 |
| 6 rpm | 12 | 11 | 14 | 14 | 14 |
| 3 rpm | 12 | 11 | 13 | 13 | 13 |
| Plastic Viscosity, cP | 25 | 24 | 31 | 32 | 37 |
| Yield point, lb/100 ft² | 18 | 21 | 23 | 24 | 25 |
| Electical Stability at 120° F., | 783 | 917 | 986 | 915 | 967 |
| volts | | | | | |
| HTHP filtrate @ 250° F., | | 12.0 | 5.2 | 3.2 | 2.2 |
| mL/30 min | | | | | |
| HTHP filtrate @ 300° F., | | 17.2 | 9.4 | 6.8 | 2.8 |
| mL/30 min | | | | | |

FIG. 6 is a graph illustrating the HTHP filtrate for the control synthetic-based fluid and samples treated with the synthetic latex composition.

Provided are compositions for a synthetic latex composition in accordance with the description provided herein. An example composition comprises a synthetic latex, and a latex stabilizer. The synthetic latex composition may be capable of losing less than 5% of its initial water concentration at the end of a one-day storage period in an open-air environment. The synthetic latex may be selected from the group consisting of styrene-butadiene rubber, cis-1,4-polybutadiene rubber, high styrene resin, butyl rubber, ethylene-propylene rubbers, neoprene rubber, nitrile rubber, cis-/trans-1,4-polyisoprene rubber, silicone rubber, chlorosulfonated polyethylene rubber, crosslinked polyethylene rubber, epichlorohydrin rubber, fluorocarbon rubber, fluorosilicone rubber, polyurethane rubber, polyacrylic rubber, polysulfide rubber, derivatives thereof, and combinations thereof. The latex stabilizer may be a polyol selected from the group consisting of glycerin, pentaerythritol, ethylene glycol, propylene glycol, ethylene glycol, diethylene glycol, 1,4-butanediol, polyethylene glycol, polypropylene glycol, poly(tetramethylene ether), bornesitol, inositol, maltitol, sorbitol, xylitol, derivatives thereof, and combinations thereof. The concentration of the latex stabilizer may be in the range of about 0.5% to about 40% w/w. The synthetic latex composition may maintain a difference in density from the top of the container to the bottom of the container of less than 0.3 pounds per gallon at the end of the exposure period. The synthetic latex composition may remain free of solids of a size sufficient to be retained on a 80-mesh sieve of the U. S. Sieve Series at the end of an exposure period. The synthetic latex composition may comprise a viscosity that does not vary more than 20% from the top of the container to the bottom at the end of the exposure period. The exposure period may be at least seven days and the synthetic latex composition may not lose less than 20% of its initial water concentration at the end of the seven-day exposure period. The synthetic latex composition may have a temperature of 32° F. or lower and remain free of solids of a size sufficient to be retained on a 80-mesh sieve. The synthetic latex composition may have a temperature of 25° F. or lower and remain free of solids of a size sufficient to be retained on a 80-mesh sieve. The synthetic latex composition may be added to a treatment fluid selected from the group consisting of drilling fluids, cement slurries, completion fluids, displacement fluids, and conformance fluids. The treatment fluid may be introduced into a wellbore.

Provided are methods for treating a subterranean formation in accordance with the description provided herein and as illustrated by FIGS. 1-6. An example method comprises providing a synthetic latex composition comprising: a synthetic latex and a latex stabilizer; and exposing the synthetic latex composition to air for an exposure period of at least one day; wherein the synthetic latex composition loses less than 5% of its initial water concentration at the end of a one-day exposure period. The synthetic latex composition may maintain a difference in density from the top of the container to the bottom of the container of less than 0.3 pounds per gallon at the end of the exposure period. The synthetic latex composition may remain free of solids of a size sufficient to be retained on a 80-mesh sieve of the U. S. Sieve Series at the end of the exposure period. The synthetic latex composition may comprise a viscosity that does not vary more than 20% from the top of the container to the bottom at the end of the exposure period. The exposure period may be at least seven days and the synthetic latex composition may lose less than 20% of its initial water concentration at the end of the seven-day exposure period. The synthetic latex composition may have a temperature of 32° F. or lower and remain free of solids of a size sufficient to be retained on a 80-mesh sieve. The synthetic latex composition may have a temperature of 25° F. or lower and remain free of solids of a size sufficient to be retained on a 80-mesh sieve. The synthetic latex composition may be added to a treatment fluid selected from the group consisting of drilling fluids, cement slurries, completion fluids, displacement fluids, and conformance fluids. The treatment fluid may be introduced into a wellbore. The synthetic latex may be selected from the group consisting of styrene-butadiene rubber, cis-1,4-polybutadiene rubber, high styrene resin, butyl rubber, ethylene-propylene rubbers, neoprene rubber, nitrile rubber, cis-/trans-1,4-polyisoprene rubber, silicone rubber, chlorosulfonated polyethylene rubber, crosslinked polyethylene rubber, epichlorohydrin rubber, fluorocarbon rubber, fluorosilicone rubber, polyurethane rubber, polyacrylic rubber, polysulfide rubber, derivatives thereof, and combinations thereof. The latex stabilizer may be a polyol selected from the group consisting of glycerin, pentaerythritol, ethylene glycol, propylene glycol, ethylene glycol, diethylene glycol, 1,4-butanediol, polyethylene glycol, polypropylene glycol, poly(tetramethylene ether), bornesitol, inositol, maltitol, sorbitol, xylitol, derivatives thereof, and combinations thereof. The concentration of the latex stabilizer may be in the range of about 0.5% to about 40% v/v.

Provided are systems for treating a subterranean formation in accordance with the description provided herein and as illustrated by FIGS. 1-6. An example system comprises a synthetic latex composition comprising: a synthetic latex and a latex stabilizer; a treatment fluid; mixing equipment capable of mixing the treatment fluid and the synthetic latex composition; and pumping equipment capable of pumping the treatment fluid into a wellbore penetrating a subterranean formation. The synthetic latex composition may be capable of losing less than 5% of its initial water concentration at the end of a one-day storage period in an open-air environment. The synthetic latex may be selected from the group consisting of styrene-butadiene rubber, cis-1,4-polybutadiene rubber, high styrene resin, butyl rubber, ethylene-propylene rubbers, neoprene rubber, nitrile rubber, cis-/trans-1,4-polyisoprene rubber, silicone rubber, chlorosulfonated polyethylene rubber, crosslinked polyethylene rubber, epichlorohydrin rubber, fluorocarbon rubber, fluorosilicone rubber, polyurethane rubber, polyacrylic rubber, polysulfide rubber, derivatives thereof, and combinations thereof. The latex stabilizer may be a polyol selected from the group consisting of glycerin, pentaerythritol, ethylene glycol, propylene glycol, ethylene glycol, diethylene glycol, 1,4-butanediol, polyethylene glycol, polypropylene glycol, poly(tetramethylene ether), bornesitol, inositol, maltitol, sorbitol, xylitol, derivatives thereof, and combinations thereof. The concentration of the latex stabilizer may be in the range of about 0.5% to about 40% w/w. The synthetic latex composition may maintain a difference in density from the top of the container to the bottom of the container of less than 0.3 pounds per gallon at the end of the exposure period. The synthetic latex composition may remain free of solids of a size sufficient to be retained on a 80-mesh sieve of the U. S. Sieve Series at the end of an exposure period. The synthetic latex composition may comprise a viscosity that does not vary more than 20% from the top of the container to the bottom at the end of the exposure period. The exposure period may be at least seven days and the synthetic latex composition may not lose less than 20% of its initial water concentration at the end of the seven-day exposure period. The synthetic latex composition may have a temperature of 32° F. or lower and remain free of solids of a size sufficient to be retained on a 80-mesh sieve. The synthetic latex composition may have a temperature of 25° F. or lower and remain free of solids of a size sufficient to be retained on a 80-mesh sieve. The synthetic latex composition may be added to a treatment fluid selected from the group consisting of drilling fluids, cement slurries, completion fluids, displacement fluids, and conformance fluids. The treatment fluid may be introduced into a wellbore.

One or more illustrative examples incorporating the examples disclosed herein are presented. Not all features of a physical implementation are described or shown in this application for the sake of clarity. Therefore, the disclosed systems and methods are well adapted to attain the ends and advantages mentioned, as well as those that are inherent therein. The particular examples disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown other than as described in the claims below. It is therefore evident that the particular illustrative examples disclosed above may be altered, combined, or modified, and all such variations are considered within the scope of the present disclosure. The systems and methods illustratively disclosed herein may suitably be practiced in the absence of any element that is not specifically disclosed herein and/or any optional element disclosed herein.

Although the present disclosure and its advantages have been described in detail, it should be understood that various changes, substitutions and alterations can be made herein without departing from the spirit and scope of the disclosure as defined by the following claims.

What is claimed is:

1. A synthetic latex composition comprising:
a synthetic latex and
a polyol latex stabilizer selected from the group consisting of glycerin, pentaerythritol, ethylene glycol, propylene glycol, ethylene glycol, diethylene glycol, 1,4-butanediol, polyethylene glycol, polypropylene glycol, poly(tetramethylene ether), bornesitol, inositol, maltitol, sorbitol, xylitol, derivatives thereof, and combinations thereof.

2. The composition of claim 1, wherein the synthetic latex composition is capable of losing less than 5% of its initial water concentration at the end of a one-day storage period in an open-air environment.

3. The composition of claim 1, wherein the synthetic latex is selected from the group consisting of styrene-butadiene rubber, cis-1,4-polybutadiene rubber, high styrene resin, butyl rubber, ethylene-propylene rubbers, neoprene rubber, nitrile rubber, cis-/trans-1,4-polyisoprene rubber, silicone rubber, chlorosulfonated polyethylene rubber, crosslinked polyethylene rubber, epichlorohydrin rubber, fluorocarbon rubber, fluorosilicone rubber, polyurethane rubber, polyacrylic rubber, polysulfide rubber, derivatives thereof, and combinations thereof.

4. The composition of claim 1, wherein the concentration of the latex stabilizer is in the range of about 0.5% to about 40% w/w.

5. The composition of claim 1, wherein the latex is a styrene-butadiene rubber;
wherein the latex stabilizer is glycerin; and wherein the latex stabilizer is present at a concentration of 20% w/w.

6. A method of treating a subterranean formation:
providing a synthetic latex composition comprising:
a synthetic latex and
a latex stabilizer; and
exposing the synthetic latex composition to air for an exposure period of at least one day; wherein the synthetic latex composition loses less than 5% of its initial water concentration at the end of a one-day exposure period;
adding the synthetic latex composition to a treatment fluid selected from the group consisting of drilling fluids, cement slurries, completion fluids, displacement fluids, and conformance fluids;
introducing the treatment fluid into a wellbore penetrating the subterranean formation.

7. The method of claim 6, wherein the synthetic latex composition maintains a difference in density from the top of the container to the bottom of the container of less than 0.3 pounds per gallon at the end of the exposure period; wherein the synthetic latex composition remains free of solids of a size sufficient to be retained on a 80-mesh sieve at the end of the exposure period; and wherein the synthetic latex composition comprises a viscosity that does not vary more than 20% from the top of the container to the bottom at the end of the exposure period.

8. The method of claim 6, wherein the exposure period is at least seven days and the synthetic latex composition loses less than 20% of its initial water concentration at the end of the seven-day exposure period.

9. The method of claim 6, wherein the synthetic latex composition has a temperature of 32° F. or lower and remains free of solids of a size sufficient to be retained on a 80-mesh sieve.

10. The method of claim 6, wherein the synthetic latex composition has a temperature of 25° F. or lower and remains free of solids of a size sufficient to be retained on a 80-mesh sieve.

11. The method of claim 6, wherein the treatment fluid is the cement slurry.

12. The method of claim 6, wherein the synthetic latex is selected from the group consisting of styrene-butadiene rubber, cis-1,4-polybutadiene rubber, high styrene resin, butyl rubber, ethylene-propylene rubbers, neoprene rubber, nitrile rubber, cis-/trans-1,4-polyisoprene rubber, silicone rubber, chlorosulfonated polyethylene rubber, crosslinked polyethylene rubber, epichlorohydrin rubber, fluorocarbon rubber, fluorosilicone rubber, polyurethane rubber, polyacrylic rubber, polysulfide rubber, derivatives thereof, and combinations thereof.

13. The method of claim 6, wherein the latex stabilizer is a polyol selected from the group consisting of glycerin, pentaerythritol, ethylene glycol, propylene glycol, ethylene glycol, diethylene glycol, 1,4-butanediol, polyethylene glycol, polypropylene glycol, poly(tetramethylene ether), bornesitol, inositol, maltitol, sorbitol, xylitol, derivatives thereof, and combinations thereof.

14. The method of claim 6, wherein the concentration of the latex stabilizer is in the range of about 0.5% to about 40% w/w.

15. The method of claim 6, wherein the latex is a styrene-butadiene rubber; wherein the latex stabilizer is glycerin; and wherein the latex stabilizer is present at a concentration of 20% w/w.

16. A system for treating a subterranean formation comprising:
a synthetic latex composition comprising:
a synthetic latex and
a latex stabilizer;
a treatment fluid;
mixing equipment capable of mixing the treatment fluid and the synthetic latex composition; and
pumping equipment capable of pumping the treatment fluid into a wellbore penetrating a subterranean formation.

17. The system of claim 16, wherein the synthetic latex composition is capable of losing less than 5% of its initial water concentration at the end of a one-day storage period in an open-air environment.

18. The system of claim 16, wherein the synthetic latex is selected from the group consisting of styrene-butadiene rubber, cis-1,4-polybutadiene rubber, high styrene resin, butyl rubber, ethylene-propylene rubbers, neoprene rubber, nitrile rubber, cis-/trans-1,4-polyisoprene rubber, silicone rubber, chlorosulfonated polyethylene rubber, crosslinked polyethylene rubber, epichlorohydrin rubber, fluorocarbon rubber, fluorosilicone rubber, polyurethane rubber, polyacrylic rubber, polysulfide rubber, derivatives thereof, and combinations thereof.

19. The system of claim 16, wherein the latex stabilizer is a polyol selected from the group consisting of glycerin, pentaerythritol, ethylene glycol, propylene glycol, ethylene glycol, diethylene glycol, 1,4-butanediol, polyethylene glycol, polypropylene glycol, poly(tetramethylene ether), bornesitol, inositol, maltitol, sorbitol, xylitol, derivatives thereof, and combinations thereof.

20. The system of claim 16, wherein the latex is a styrene-butadiene rubber; wherein the latex stabilizer is glycerin; and wherein the latex stabilizer is present at a concentration of 20% w/w.
